(19) United States
(12) Patent Application Publication
(10) Pub. No.: US 2025/0269903 A1
(43) Pub. Date: Aug. 28, 2025

(54) REINFORCEMENT MEMBER ASSEMBLY FOR SIDE SILL OF VEHICLE

(71) Applicants: Hyundai Motor Company, Seoul (KR); Kia Corporation, Seoul (KR)

(72) Inventors: Se-Hyun JUNG, Hwaseong-si (KR); Seung-Hyun KANG, Hwaseong-si (KR); Han-Seok SONG, Hwaseong-si (KR)

(73) Assignees: Hyundai Motor Company, Seoul (KR); Kia Corporation, Seoul (KR)

(21) Appl. No.: 18/956,506

(22) Filed: Nov. 22, 2024

(30) Foreign Application Priority Data
Feb. 28, 2024 (KR) 10-2024-0028846

(51) Int. Cl. B62D 21/15; B62D 25/02

(52) U.S. Cl. CPC B62D 21/157; B62D 25/025

(57) ABSTRACT

A reinforcement member assembly for a side sill of a vehicle includes an upper reinforcement member formed in a longitudinal direction of the vehicle and provided inside a side sill of the vehicle; a lower reinforcement member positioned below the upper reinforcement member, including one side in a width direction of the vehicle, which is connected to the upper reinforcement member in the longitudinal direction of the vehicle, provided inside the side sill; and internal reinforcement members connected to a bottom surface of the upper reinforcement member and an upper surface of the lower reinforcement member, respectively, which reduces weight of the vehicle and improves strength of the vehicle against a side collision.

### CROSS-REFERENCE TO RELATED APPLICATION

The present application claims priority to Korean Patent Application No. 10-2024-0028846, filed on Feb. 28, 2024, the entire contents of which is incorporated herein for all purposes by this reference.

### BACKGROUND OF PRESENT DISCLOSURE

### Field of Present Disclosure

The present disclosure relates to a reinforcement member assembly for a side sill of a vehicle, which enables weight reduction and improves side collision performance.

### Description of Related Art

Referring to FIGS. 1-3, a side sill 110 is provided at a lower portion of a side surface of a vehicle in a longitudinal direction of the vehicle.

The side sill 110 is formed by joining a side sill inner 111 formed convexly toward an interior of the vehicle and a side sill outer 112 formed convexly toward an outside of the vehicle. Upper and lower end portions of the side sill inner 111 and the side sill outer 112 are connected to each other to form a hollow structure in a longitudinal direction of the vehicle, forming a lower structure of the vehicle.

Meanwhile, a reinforcement member 120 is provided inside the side sill 110 to reinforce rigidity of the side sill 110. For example, the reinforcement member 120 is manufactured by extruding an aluminum alloy. Since the reinforcement member 120 is made of a different material from those of the side sill inner 111 and the side sill outer 112, which are typically manufactured from a steel sheet, the reinforcement member 120 may not be connected to the side sill inner 111 or the side sill outer 112 by welding.

To fasten the reinforcement member 120 to the side sill inner 111 or the side sill outer 112, brackets 121 and 122 are connected to the reinforcement member 120 using a screw 123 through a flow drill screw (FDS) method, and then the brackets 121 and 122 are connected to the side sill inner 111 or the side sill outer 112 by welding or the like so that the reinforcement member 120 may be provided inside the side sill 110.

However, the reinforcement member 120 is manufactured by extruding an expensive aluminum alloy, increasing manufacturing costs of the vehicle. Furthermore, to install the reinforcement member 120, a process of fastening the brackets 121 and 122 by the FDS method and a process of welding the brackets 121 and 122 to the side sill inner 111 or the side sill outer 112 are discretely performed so that additional production lines should be provided to increase an amount of work as well as production costs of the vehicle. For example, the brackets 121 and 122 are firstly connected to the reinforcement member 120, and then connected to an assembly of the inner panel 113 of the vehicle such as a center pillar inner panel and the side sill inner 111, and the side sill outer 112 is finally connected to outer an external side of the assembly.

Furthermore, since the reinforcement member 120 is manufactured by a extrusion process, a thickness of a cross section of the reinforcement member 120 inevitably becomes thick, and as a result, a gap between a circumference of the reinforcement member 120 and the side sill inner 111 or the side sill outer 112 becomes narrow. This prevents an electrodeposition solution from flowing smoothly during a painting process, causing the electrodeposition solution to clump together in some areas resulting in excessive painting or causing a painting defect in which the electrodeposition solution is not applied to some areas. That is, since a gap between the reinforcement member 120, the side sill inner 111, and the side sill outer 112 is narrow as shown in FIG. 3 and a gap between the reinforcement member 120 and the side sill inner 111 and the side sill outer 112 is narrow as shown in FIG. 4 at both sides and a lower portion of the reinforcement member 120, the electrodeposition solution may not flow smoothly, and thus the electrodeposition solution is not applied uniformly, causing a painting defect.

Furthermore, for a vehicle such as a multi-purpose vehicle (MPV), a battery is provided in the vehicle. As the battery is provided, a weight of the vehicle increases, and thus a load that the vehicle should support in the event of a side collision increases. However, since a sliding door is usually provided in the vehicle such as an MPV, a cross-sectional area of the side sill 110 is reduced to install a rail for opening and closing the sliding door, and thus it is difficult to apply the reinforcement member 120 made by extruding the aluminum alloy, and there is a problem in that a bearing capacity against a side collision is reduced.

As described above, when the bearing capacity against the side collision is weakened, there is a problem in that the battery provided for electrification is damaged due to the side collision.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a reinforcement member assembly for a side sill of a vehicle, which may reduce a weight compared with a reinforcement member of an aluminum extrusion material and exhibit comparable collision performance.

An exemplary embodiment of the present disclosure is also directed to providing a reinforcement member assembly for a side sill of a vehicle, which is easily provided inside the side sill to reduce manufacturing costs and does not hinder a flow of an electrodeposition solution during a painting process.

Other objects and advantages of the present disclosure may be understood by the following description and become apparent with reference to the exemplary embodiments of the present disclosure. Also, it is obvious to those skilled in the art to which the present disclosure pertains that the objects and advantages of the present disclosure may be realized by the means as claimed and combinations thereof.

In accordance with an exemplary embodiment of the present disclosure, there is provided a reinforcement member assembly for a side sill of a vehicle, which includes an upper reinforcement member formed in a longitudinal direction of the vehicle and provided inside the side sill of the vehicle; a lower reinforcement member positioned below the upper reinforcement member, including one side in a width direction of the vehicle, which is connected to the upper reinforcement member in the longitudinal direction of the vehicle, provided inside the side sill; and an internal reinforcement member connected to a bottom surface of the upper reinforcement member and an upper surface of the lower reinforcement member, respectively.

The upper reinforcement member may include an upper surface and a side surface bent downwardly from the upper surface, and the lower reinforcement member may include a lower surface positioned below the upper surface of the upper reinforcement member and a side surface bent upwards from the lower surface and connected to the side surface of the upper reinforcement member.

The upper reinforcement member may include bead portions formed on the upper surface to be higher than the upper surface in a width direction of the vehicle, and the bead portions may be formed at intervals in the longitudinal direction of the vehicle.

A through-hole passing through the bead portion may be formed in the bead portion.

The lower reinforcement member may include bead portions formed on the lower surface to be lower than the lower surface in the width direction of the vehicle, and the bead portions may be formed at intervals in the longitudinal direction of the vehicle.

A through-hole may be formed on each of the lower surface and the side surface of the upper reinforcement member.

The internal reinforcement member may be provided as a plurality of internal reinforcement members and disposed at intervals in the longitudinal direction of the vehicle.

The internal reinforcement member may include an upper bonding portion connected to the bottom surface of the upper reinforcement member, a lower bonding portion disposed at both end portions of the upper bonding portion in the longitudinal direction of the vehicle and connected to the upper surface of the lower reinforcement member, and a connection portion which connects the upper bonding portion and the lower bonding portion.

A bead portion may be formed in the upper bonding portion to be lower than the upper bonding portion in the width direction of the vehicle.

A bead portion may be formed on an upper surface of the upper reinforcement member to be higher than the upper surface in the width direction of the vehicle, and the bead portion of the internal reinforcement member may be positioned below the bead portion.

A through-hole may be formed in the bead portion.

The reinforcement member assembly may further include a connection member whose front and rear end portions are connected to internal reinforcement members adjacent to each other in the longitudinal direction of the vehicle.

A bead portion may be formed in the connection member in the width direction of the vehicle.

A bead portion may be formed on an upper surface of the upper reinforcement member to be higher than the upper surface in the width direction of the vehicle, and the bead portion of the connection member may be positioned below the bead portion of the upper reinforcement member.

The connection member may be disposed between the upper reinforcement member and the internal reinforcement member and connected thereto.

The connection member may include a first internal reinforcement member disposed as a plurality of first internal reinforcement members at intervals in the longitudinal direction of the vehicle, and a second internal reinforcement member disposed with an interval from a first internal reinforcement member, among the first internal reinforcement members, disposed at a frontmost or rearmost position in the longitudinal direction of the vehicle.

The upper reinforcement member and the lower reinforcement member may be connected to a side sill inner of the side sill.

The reinforcement member assembly may further include an extension member connected to a front or a rear end portion of the lower reinforcement member.

A second connection member connects the first internal reinforcement member and the second internal reinforcement member, and the second connection member may be formed to have a different length from the first connection member.

The extension member may be formed to have substantially the same cross-sectional shape as the lower reinforcement member.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a perspective view exemplarily illustrating a state in which a reinforcement member is provided inside a side sill according to the related art.

FIG. 2 is a perspective view exemplarily illustrating a state in which a bracket is provided on the reinforcement member according to the related art.

FIG. 3 is a cross-sectional view exemplarily illustrating a center pillar portion of a vehicle in the side sill according to the related art.

FIG. 4 is a cross-sectional view exemplarily illustrating a center pillar of the vehicle in the side sill according to the related art when viewed from the rear.

FIG. 5 is a partial perspective view exemplarily illustrating a state in which a reinforcement member assembly for a side sill according to an exemplary embodiment of the present disclosure is provided at a side sill internal.

FIG. 6 is an exploded perspective view of FIG. 5 illustrating a state in which the reinforcement member assembly for a side sill according to an exemplary embodiment of the present disclosure is separated from the side sill internal.

FIG. 7 is a perspective view exemplarily illustrating the reinforcement member assembly for a side sill according to an exemplary embodiment of the present disclosure.

FIG. 8 is an exploded perspective view of FIG. 7 illustrating the reinforcement member assembly for a side sill according to an exemplary embodiment of the present disclosure.

FIG. 9 is a bottom perspective view of FIG. 5 illustrating the reinforcement member assembly for a side sill according to an exemplary embodiment of the present disclosure.

FIG. 10 is a side view of FIG. 5 illustrating the reinforcement member assembly for a side sill according to an exemplary embodiment of the present disclosure.

FIG. 11 is a cross-sectional view taken along line I-I of FIG. 10.

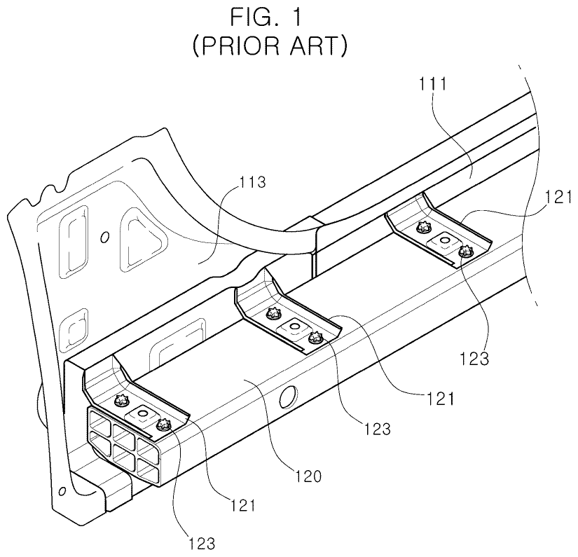

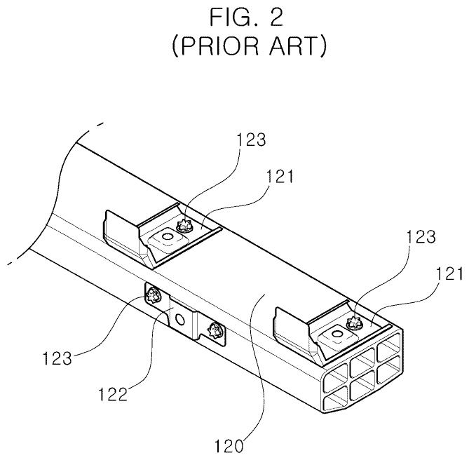

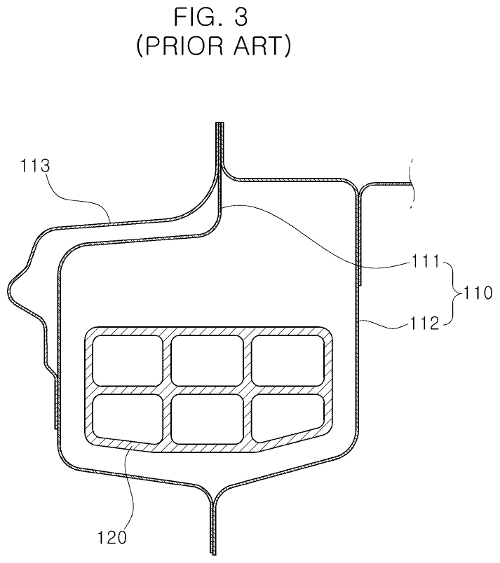

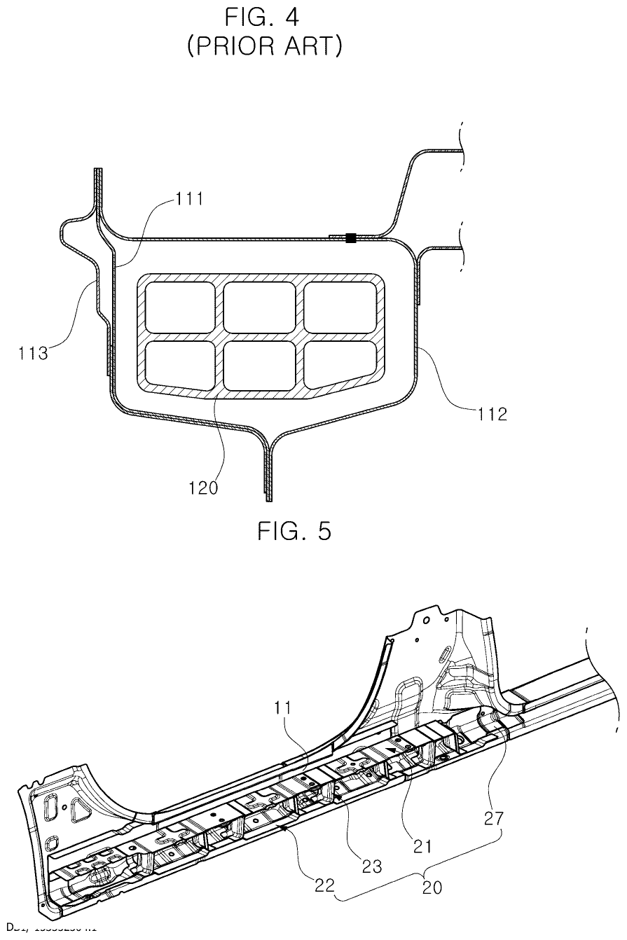

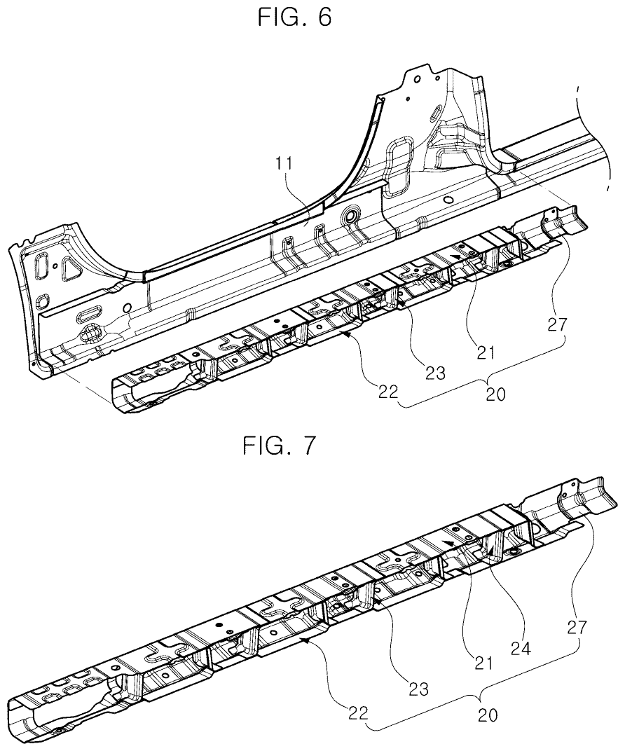

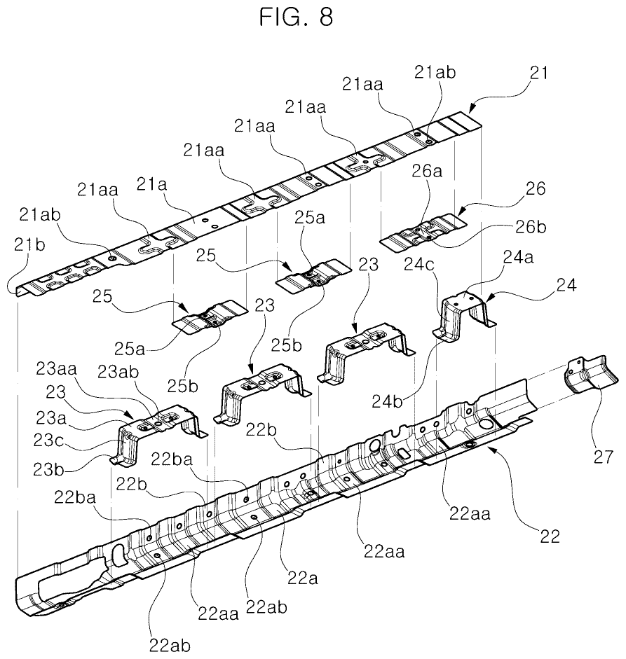

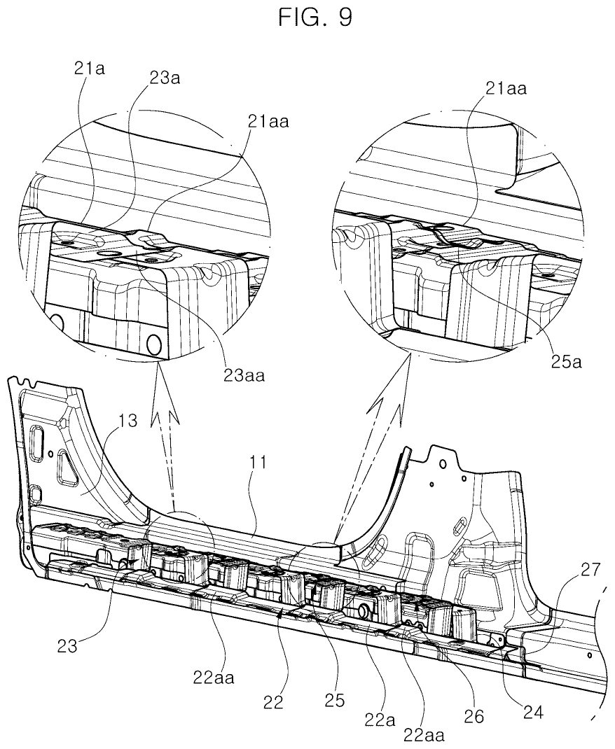

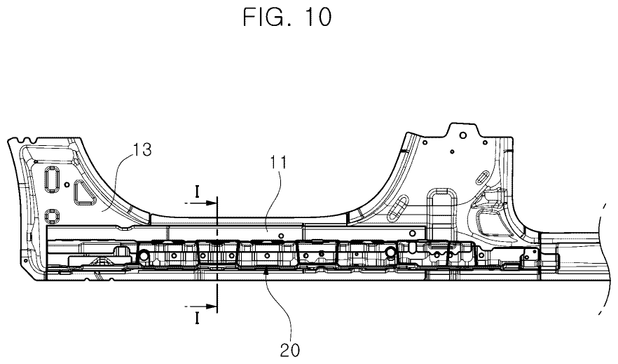

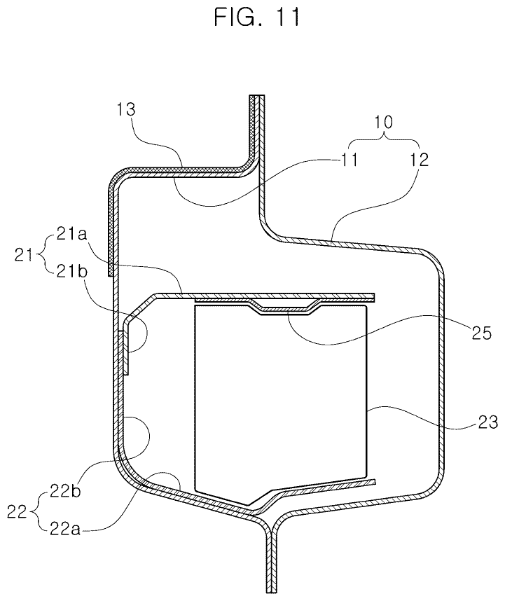

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, a reinforcement member assembly for a side sill according to an exemplary embodiment of the present disclosure will be described in detail with reference to the accompanying drawings.

A reinforcement member assembly 20 for a side sill according to an exemplary embodiment of the present disclosure may be provided inside a side sill 10 of a vehicle to improve a rigidity of the side sill 10.

The side sill 10 may be formed by bonding a side sill inner 11 formed convexly toward an interior of the vehicle and a side sill outer 12 formed convexly toward an outside of the vehicle.

The reinforcement member assembly 20 for a side sill may be provided inside the side sill 10 to improve the rigidity of the side sill 10.

The reinforcement member assembly 20 for a side sill according to an exemplary embodiment of the present disclosure may include an upper reinforcement member 21 formed in a longitudinal direction of the vehicle and provided inside the side sill 10 of the vehicle; a lower reinforcement member 22 positioned below the upper reinforcement member 21, including one side in a width direction of the vehicle, which is connected to the upper reinforcement member 21 in the longitudinal direction of the vehicle, provided inside the side sill 10; and internal reinforcement members 23 and 24 connected to a bottom surface of the upper reinforcement member 21 and an upper surface of the lower reinforcement member 22, respectively.

The upper reinforcement member 21 may be formed in the longitudinal direction of the vehicle.

The upper reinforcement member 21 may include an upper surface 21a formed in the longitudinal direction of the vehicle and a side surface 21b extending downwardly from a side surface of the upper surface 21a. The upper reinforcement member 21 may include a bent cross section by the upper surface 21a and the side surface 21b, which is formed continuously in the longitudinal direction of the vehicle, so that a cross section of an upper side of the reinforcement member assembly 20 for a side sill is formed.

A bead portion 21aa may be formed on the upper surface 21a to be higher than the upper surface 21a. Since the bead portion 21aa is formed higher than the upper surface 21a in the width direction of the vehicle, the bead portion 21aa improves a side collision load that the upper surface 21a may experience in the event of a side collision of the vehicle. The bead portion 21aa may be formed as a plurality of bead portions 21aa on the upper surface 21a at intervals therebetween in the longitudinal direction of the vehicle. Since the bead portion 21aa formed on the upper surface 21a is formed to be higher than the upper surface 21a, the bead portion 21aa may include a convex shape upwards from the upper surface 21a. Since the bead portion 21aa supports the collision load input to the upper surface 21a in the width direction of the vehicle, rigidity of the reinforcement member assembly 20 for a side sill may be improved. The bead portion 21aa may increase a cross-sectional coefficient of the upper surface 21a to improve the rigidity. The bead portion 21aa may be basically formed in the width direction of the vehicle, and alternatively, some bead portions 21aa may be additionally formed to protrude in the longitudinal direction of the vehicle.

A through-hole 21ab may be formed in the bead portion 21aa. Since the through-hole 21ab is formed to pass through the bead portion 21aa, when a vehicle body of the vehicle is electrodeposition-painted, an electrodeposition solution may freely flow through the through-hole 21ab to facilitate the application of the electrodeposition solution, preventing the electrodeposition solution from clumping in some areas or the electrodeposition solution from not being flown.

The lower reinforcement member 22 may be positioned below the upper reinforcement member 21, and one side of the lower reinforcement member 22 may be connected to the upper reinforcement member 21 in the longitudinal direction of the vehicle.

The lower reinforcement member 22 may be provided inside the side sill 10 in a state of being connected to the upper reinforcement member 21, and thus an assembly of the upper reinforcement member 21 and the lower reinforcement member 22 may form an integrated structural body.

The lower reinforcement member 22 may include a lower surface 22a positioned below the upper surface 21a, and a side surface 22b bent upwards from the lower surface 22a and connected to the side surface 21b of the upper reinforcement member 21. The lower reinforcement member 22 may form a cross section of a lower portion in the reinforcement member assembly 20 for a side seal by forming a bent cross section by the lower surface 22a and the side surface 22b.

The lower reinforcement member 22 may be connected to the upper reinforcement member 21 so that the assembly thereof becomes a state in which a U-shape is rotated at 90 degrees. Accordingly, the rigidity of the side sill 10 may be reinforced by the cross-sectional structure formed by the upper reinforcement member 21 and the lower reinforcement member 22. The assembly of the lower reinforcement member 22 and the upper reinforcement member 21 may include an open cross section facing the outside of the vehicle by rotating a ‘U’-shaped cross section so that the side collision load input in the width direction of the vehicle is supported. The side surface 22b of the lower reinforcement member 22 may be connected to the side surface 21b of the upper reinforcement member 21 through welding, for example, spot welding.

Bead portions 22aa may be formed on the lower surface 22a of the lower reinforcement member 22. The bead portion 22aa may be formed on the lower surface 22a to be lower than the lower surface 22a in the width direction of the vehicle. The bead portions 22aa may be formed on the lower surface 22a at intervals therebetween in the longitudinal direction of the vehicle to increase the collision load that the lower surface 22a may support in the event of a side collision of the vehicle, improving rigidity of the lower surface 22a. The bead portion 22aa may be formed to extend to the side surface 22b.

A through-hole 22ab passing through the lower surface 22a may be formed on the lower surface 22a of the lower reinforcement member 22. Furthermore, a through-hole 22ba passing through the side surface 22b may be also formed on the side surface 22b. The through-holes 22ab and 22ba formed on the lower surface 22a and the side surface 22b, respectively, may allow the electrodeposition solution to flow smoothly during the painting process and secure that the electrodeposition solution is uniformly applied.

The internal reinforcement members 23 and 24 may be connected to the bottom surface of the upper reinforcement member 21 and the upper surface of the lower reinforcement member 22, respectively. The internal reinforcement members 23 and 24 may be provided as a plurality of internal reinforcement members 23 and 24 disposed at intervals in the longitudinal direction of the vehicle. Since the upper reinforcement member 21 and the lower reinforcement member 22 are connected to each other through the internal reinforcement members 23 and 24, in the event of a side collision, the upper reinforcement member 21 and the lower reinforcement member 22 is configured to prevent the upper reinforcement member 21 and the lower reinforcement member 22 from being separated. That is, since the upper reinforcement member 21 and the lower reinforcement member 22 are connected by the internal reinforcement members 23 and 24 in the longitudinal direction of the vehicle, when a side collision of the vehicle occurs, the upper reinforcement member 21 and the lower reinforcement member 22 may prevent a phenomenon in which the upper reinforcement member 21 and the lower reinforcement member 22 are separated from each other.

Furthermore, the internal reinforcement members 23 and 24 may also be configured to directly support the side collision load. Since the internal reinforcement members 23 and 24 are formed as an open cross section in the width direction of the vehicle, the internal reinforcement members 23 and 24 may also support the side collision load.

The internal reinforcement members 23 and 24 may include a plurality of first internal reinforcement members 23 disposed in the longitudinal direction of the vehicle and a plurality of second internal reinforcement members 24 disposed in front of or behind the first internal reinforcement members 23.

The first internal reinforcement member 23 may include an upper bonding portion 23a connected to the bottom surface of the upper reinforcement member 21, a lower bonding portion 23b disposed at both end portions of the upper bonding portion 23a in the longitudinal direction of the vehicle and connected to the upper surface of the lower reinforcement member 22, and a connection portion 23c connecting the upper bonding portion 23a and the lower bonding portion 23b.

The upper bonding portion 23a may be connected to the bottom surface of the upper reinforcement member 21, that is, a bottom surface of the upper surface 21a. The upper bonding portion 23a may be formed to have a predetermined length in the longitudinal direction of the vehicle and may be connected to the upper surface 21a, fastening the first internal reinforcement member 23 to the upper reinforcement member 21.

A bead portion 23aa may be formed in the upper bonding portion 23a to be lower than the upper bonding portion 23a in the width direction of the vehicle. The bead portion 23aa formed in the upper bonding portion 23a may be positioned below the bead portion 21aa formed in the upper reinforcement member 21 when the first internal reinforcement member 23 is connected to the upper reinforcement member 21 (see FIG. 9). While the bead portion 21aa of the upper reinforcement member 21 includes a convex shape, the bead portion 23aa of the upper bonding portion 23a may include a concave shape, and thus when the upper bonding portion 23a is connected to the upper reinforcement member 21, the bead portions 21aa and 23a may form a cylindrical structure in the width direction of the vehicle. This may support a side collision load in the event of a side collision.

In the first internal reinforcement member 23, a through-hole 23ab may be formed in the bead portion 23aa to allow the electrodeposition solution to flow smoothly during the painting process.

Similar to the first internal reinforcement member 23, the second internal reinforcement member 24 may include an upper bonding portion 24a connected to the bottom surface of the upper reinforcement member 21, a lower bonding portion 24b disposed at both end portions of the upper bonding portion 24a in the longitudinal direction of the vehicle and connected to the upper surface of the lower reinforcement member 22, and a connection portion 24c connecting the upper bonding portion 24a and the lower bonding portion 24b.

The second internal reinforcement member 24 may be connected to the upper reinforcement member 21 and the lower reinforcement member 22 by welding, and similar to the first internal reinforcement member 23, the second internal reinforcement member 24 may prevent the upper reinforcement member 21 and the lower reinforcement member 22 from being separated in the event of a side collision.

The second internal reinforcement member 24 is configured to connect the upper reinforcement member 21 and the lower reinforcement member 22 at a front side or a rear side of the first internal reinforcement member 23 disposed as a plurality of first internal reinforcement members 23. That is, the second internal reinforcement member 24 may be positioned in front of the first internal reinforcement member 23, which is positioned at the foremost position among the first internal reinforcement members 23, in the longitudinal direction of the vehicle or positioned behind the first internal reinforcement member 23, which is positioned at the rearmost position among the first internal reinforcement members 23, in the longitudinal direction of the vehicle.

Connection members 25 and 26 may be disposed in the longitudinal direction of the vehicle, and front and rear end portions of the connection members 25 and 26 may be connected to the upper bonding portions 23a and 24a of the internal reinforcement members 23 and 24.

In the internal reinforcement members 23 and 24, the upper bonding portions 23a and 24a may be connected to the bottom surface of the upper reinforcement member 21, and thus the connection members 25 and 26 may be disposed between the upper reinforcement member 21 and the internal reinforcement members 23 and 24.

The connection members 25 and 26 may include a first connection member 25 connecting the two first internal reinforcement members 23 positioned adjacent to each other in the longitudinal direction of the vehicle, and a second connection member 26 connecting the first internal reinforcement member 23 and the second internal reinforcement member 24.

The first connection member 25 may connect the two internal reinforcement members 23 and 24 disposed in the longitudinal direction of the vehicle, and may prevent rotation or deformation of the internal reinforcement members 23 and 24 in the event of a side collision of the vehicle, preventing the internal reinforcement members 23 and 24 from being separated from the upper reinforcement member 21 and the lower reinforcement member 22.

The first connection member 25 may be disposed between the upper reinforcement member 21 and the first internal reinforcement member 23 to connect two internal reinforcement members 23 and 24 disposed adjacent to each other in the longitudinal direction of the vehicle.

The first connection member 25 may be connected to the upper reinforcement member 21 and the first internal reinforcement member 23 by welding.

A bead portion 25a may be formed in the first connection member 25 in the width direction of the vehicle. The bead portion 25a may be formed to be concave downward and may be positioned below the bead portion 21aa formed in the upper reinforcement member 21 (see FIG. 9). When the first connection member 25 is connected to the upper reinforcement member 21, the bead portions 21aa and 25a formed in the upper reinforcement member 21 and the first connection member 25 may form a cylindrical structure in the width direction of the vehicle, supporting a side collision load in the event of a side collision.

A through-hole 25b may be formed in the first connection member 25 to facilitate the flow of the electrodeposition solution during the painting process.

The second connection member 26 may be formed in a shape similar to a shape of the first connection member 25. The second connection member 26 may be formed to have a different length from the first connection member 25. Since the second internal reinforcement member 24 is formed in a different form from the first internal reinforcement member 23, and a distance between the second internal reinforcement member 24 and the first internal reinforcement member 23 adjacent thereto may be different from a distance at which the first internal reinforcement members 23 are disposed, the second connection member 26 may be formed to have a different length from the first connection member 25.

Similar to the first connection member 25, a bead portion 26a may be formed in the second connection member 26 in the width direction of the vehicle. Since the bead portion 26a is also positioned below the bead portion 21aa formed in the upper reinforcement member 21 and is formed to be concave downward, the bead portion 21aa and the bead portion 26a may also form a cylindrical structure in the width direction of the vehicle, supporting a side collision load in the event of a side collision.

A through-hole 26b may be formed to pass through the second connection member 26 to facilitate the flow of the electrodeposition solution during the painting process.

The second connection member 26 may be also connected to the bottom surface of the upper reinforcement member 21, and the upper bonding portion 23a of the first internal reinforcement member 23 and the upper bonding portion 24a of the second internal reinforcement member 24 may be connected to a bottom surface of the second connection member 26. Thus, the second connection member 26 may be disposed between the upper reinforcement member 21 and the upper bonding portion 23a or between the upper reinforcement member 21 and the upper bonding portion 24a.

The second connection member 26 may be connected to the upper reinforcement member 21, the first internal reinforcement member 23, and the second internal reinforcement member 24 by welding.

An extension member 27 may be connected to a front end portion or a rear end portion of the lower reinforcement member 22. The extension member 27 may be formed to have substantially the same cross-sectional shape as the lower reinforcement member 22 and is configured to extend the lower reinforcement member 22.

The reinforcement member assembly 20 for a side sill according to an exemplary embodiment of the present disclosure may be provided inside the side sill 10 of the vehicle. The upper reinforcement member 21 and the lower reinforcement member 22 may be connected to the side sill inner 11 of the side sill 10 by welding. The reinforcement member assembly 20 for a side sill may be assembled in advance, and then during an assembly process of the side sill 10, the reinforcement member assembly 20 for a side sill may be connected to an assembly of the side sill inner 11 and the inner panel 13 of the vehicle body.

The reinforcement member assembly 20 of a side sill may be connected to the side sill inner 11, and then the side sill outer 12 may be connected to an external side of the assembly of the side sill inner 11 and the reinforcement member assembly 20 of a side sill. Thus, the side sill 10 provided with the reinforcement member assembly 20 of a side sill may be formed therein.

Since the reinforcement member assembly 20 of a side sill is connected to the side sill inner 11 by welding, an amount of work required may be reduced compared to when applying the reinforcement member 120 made of an aluminum extrusion material, reducing the time and cost required for production of the vehicle.

Furthermore, since each member forming the reinforcement member assembly 20 of a side sill is manufactured by welding metal plates such as steel sheets, it is possible to reduce a weight compared to the conventional thick aluminum extrusion material and allow the flow of the electrodeposition solution inside to become smoother.

An operation of the reinforcement member assembly 20 of a side sill according to an exemplary embodiment of the present disclosure including the above configuration will be described below.

The reinforcement member assembly 20 for a side sill according to an exemplary embodiment of the present disclosure may be provided inside the side sill 10.

When a side collision of the vehicle occurs, a collision load may be applied to the side sill outer 12.

The collision load input to the side sill outer 12 may be transmitted to the reinforcement member assembly 20 for the side sill 10.

Since the upper reinforcement member 21 and the lower reinforcement member 22 are connected to each other, and a cross section thereof may be formed to face outer an external side in the width direction of the vehicle, the upper surface 21a of the upper reinforcement member 21 and the lower surface 22a of the lower reinforcement member 22 may support the collision load being applied thereto.

Furthermore, in the event of a side collision, since the first internal reinforcement member 23 and the second internal reinforcement member 24 prevent the upper reinforcement member 21 and the lower reinforcement member 22 from being spread or separated, the upper reinforcement member 21 and the lower reinforcement member 22 may firmly support the collision load.

Furthermore, since the bead portions 21aa, 22aa, 23aa, 25a, and 26a are formed in the upper reinforcement member 21, the lower reinforcement member 22, the first internal reinforcement member 23, the first connection member 25, and the second connection member 26, respectively, the bead portions 21aa, 22aa, 23aa, 25a, and 26a may firmly support a load from a side collision.

According to a reinforcement member assembly for a side sill of a vehicle of the present disclosure, which includes the above-described configuration, the reinforcement member assembly for a side sill may support a collision load input through a side surface of the vehicle so that a phenomenon in which the side sill is excessively deformed may be prevented.

As the deformation of the side sill is reduced in the event of a side collision, deformation of a compartment due to the side collision may be reduced so that a survival space for occupants may be expanded.

Furthermore, in eco-friendly vehicles, such as electric vehicles, in which batteries are provided below floors of the vehicles, a bearing capacity against a side collision may be increased so that damage to the battery due to side collision may be prevented.

For installation of a sliding door in a vehicle such as a multi-purpose vehicle (MVP) to which the sliding door is applied, even when a cross-sectional size of the side sill becomes small, a collision load may be sufficiently supported.

Since a thin metal plate is used inside the side sill instead of a thick aluminum extrusion material, a weight reduction of the reinforcement member assembly for a side sill may be achieved compared with the reinforcement member of the aluminum extrusion material.

Furthermore, as a gap between the reinforcement member assembly for a side sill, a side sill internal, and a side sill outer is increased, a flow of an electrodeposition solution may be facilitated. Furthermore, since a through-hole through which the electrodeposition solution flows is formed, a phenomenon of the electrodeposition solution clumping or not being applied during a painting process is prevented so that painting quality may be improved and corrosion resistance may be improved.

Furthermore, since the reinforcement member assembly for a side sill is connected to the side sill inner in a single process, an amount of work required may be reduced and there may be no need to use expensive aluminum material for the reinforcement member so that production costs may be reduced.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A reinforcement member assembly for a side sill of a vehicle, the reinforcement member assembly comprising:
an upper reinforcement member formed in a longitudinal direction of the vehicle and provided inside the side sill of the vehicle;
a lower reinforcement member positioned below the upper reinforcement member, including one side in a width direction of the vehicle, which is connected to the upper reinforcement member in the longitudinal direction of the vehicle, provided inside the side sill; and
an internal reinforcement member connected to a bottom surface of the upper reinforcement member and an upper surface of the lower reinforcement member, respectively.

2. The reinforcement member assembly of claim 1,
wherein the upper reinforcement member includes an upper surface and a side surface bent downwardly from the upper surface, and
wherein the lower reinforcement member includes a lower surface positioned below the upper surface of the upper reinforcement member and a side surface bent upwards from the lower surface and connected to the side surface of the upper reinforcement member.

3. The reinforcement member assembly of claim 2,
wherein the upper reinforcement member includes bead portions formed on the upper surface of the upper reinforcement member to be higher than the upper surface of the upper reinforcement member in the width direction of the vehicle, and
wherein the bead portions are formed at intervals in the longitudinal direction of the vehicle.

4. The reinforcement member assembly of claim 3, wherein a through-hole passing through each bead portion is formed in each bead portion of the upper reinforcement member.

5. The reinforcement member assembly of claim 2,
wherein the lower reinforcement member includes bead portions formed on the lower surface of the lower reinforcement member to be lower than the lower surface of the lower reinforcement member in the width direction of the vehicle, and
wherein the bead portions of the lower reinforcement member are formed at intervals in the longitudinal direction of the vehicle.

6. The reinforcement member assembly of claim 5, wherein a through-hole passing is formed on each of the lower surface of the lower reinforcement member and the side surface of the upper reinforcement member.

7. The reinforcement member assembly of claim 1, wherein the internal reinforcement member is in plural and the plurality of internal reinforcement members are disposed at intervals in the longitudinal direction of the vehicle.

8. The reinforcement member assembly of claim 1, wherein the internal reinforcement member includes:
an upper bonding portion connected to the bottom surface of the upper reinforcement member;
a lower bonding portion disposed at first and second end portions of the upper bonding portion in the longitudinal direction of the vehicle and connected to the upper surface of the lower reinforcement member; and
a connection portion which connects the upper bonding portion and the lower bonding portion.

9. The reinforcement member assembly of claim 8, wherein a bead portion of the internal reinforcement is formed in the upper bonding portion to be lower than the upper bonding portion in the width direction of the vehicle.

10. The reinforcement member assembly of claim 9,
wherein a bead portion of the upper reinforcement member is formed on an upper surface of the upper reinforcement member to be higher than the upper surface of the upper reinforcement member in the width direction of the vehicle, and
wherein the bead portion of the internal reinforcement member is positioned below the bead portion of the upper reinforcement member.

11. The reinforcement member assembly of claim 9, wherein a through-hole is formed in the bead portion of the upper reinforcement member.

12. The reinforcement member assembly of claim 1,
wherein the internal reinforcement is in plural, and
wherein the reinforcement member assembly further includes:
a first connection member whose front and rear end portions are connected to the plurality of internal reinforcement members adjacent to each other in the longitudinal direction of the vehicle.

13. The reinforcement member assembly of claim 12, wherein a bead portion is formed in the first connection member in the width direction of the vehicle.

14. The reinforcement member assembly of claim 13,
wherein a bead portion is formed on an upper surface of the upper reinforcement member to be higher than the upper surface of the upper reinforcement member in the width direction of the vehicle, and
wherein the bead portion of the first connection member is positioned below the bead portion of the upper reinforcement member.

15. The reinforcement member assembly of claim 12, wherein the first connection member is disposed between the upper reinforcement member and the internal reinforcement member and connected thereto.

16. The reinforcement member assembly of claim 15, wherein the internal reinforcement member includes:
a plurality of first internal reinforcement members disposed at intervals in the longitudinal direction of the vehicle; and
a second internal reinforcement member disposed with an interval from a first internal reinforcement member, among the first internal reinforcement members, disposed at a frontmost or rearmost position in the longitudinal direction of the vehicle.

17. The reinforcement member assembly of claim 1, wherein the upper reinforcement member and the lower reinforcement member are connected to a side sill inner of the side sill.

18. The reinforcement member assembly of claim 1, further including:
an extension member connected to a front end portion or a rear end portion of the lower reinforcement member.

19. The reinforcement member assembly of claim 16,
wherein the internal reinforcement member includes a first internal reinforcement member and a second internal reinforcement member,
wherein a second connection member connects the first internal reinforcement member and the second internal reinforcement member, and
wherein the second connection member is formed to have a different length from a first connection member.

20. The reinforcement member assembly of claim 18, wherein the extension member is formed to have substantially the same cross-sectional shape as the lower reinforcement member.
